(19) United States
(12) Patent Application Publication
(10) Pub. No.: US 2021/0320354 A1
(43) Pub. Date: Oct. 14, 2021

(54) RECHARGEABLE LITHIUM ION BATTERY WITH IMPROVED LIFE CHARACTERISTICS

(71) Applicants: UMICORE, Brussels (BE); UMICORE KOREA LTD., Chungcheongnam-do (KR)

(72) Inventors: Liang ZHU, Chungcheongnam-do (KR); Jeong-Rae KIM, Chungcheongnam-do (KR); AReum PARK, Chungcheongnam-do (KR); YuRi LEE, Chungcheongnam-do (KR)

(21) Appl. No.: 17/259,662

(22) PCT Filed: Jul. 10, 2019
(86) PCT No.: PCT/EP2019/068552

§ 371 Date: Jan. 12, 2021

(30) Foreign Application Priority Data
Jul. 16, 2018 (EP) 18183630.5

(51) Int. Cl. H01M 50/103; H01M 50/136; H01M 4/525; H01M 10/0525

(52) U.S. Cl. CPC H01M 50/103; H01M 50/136; H01M 2004/021; H01M 10/0525; H01M 4/525

(57) ABSTRACT

A secondary Li-ion battery comprising a casing comprising as battery parts: a positive electrode comprising a powderous positive electrode active material, a negative electrode, a separator, and an electrolyte, wherein the casing is provided with means for maintaining the exterior form of the casing, and wherein the positive electrode active material has the general formula Li₁₊ₐ(NiₓCo_{y}M_{z})₁₋ₐO₂, wherein M=M′_{1-b}A_{b}, M′ being either one or both of Al and Mg, and A being a dopant with b≤0.10, and wherein −0.03≤a≤0.03, 0.80≤×≤0.95, 0.05≤y≤0.20, z≤0.10, with x+y+z=1, and wherein the positive electrode active material has a crystallite size ≤43 nm as determined by the Sherrer equation based on the peak of the (104) plane obtained from the X-ray diffraction pattern using a Cu Kα radiation source, and wherein the positive electrode active material further comprises between 0.4 and 0.6 wt % LiOH.

### TECHNICAL FIELD AND BACKGROUND

This invention relates to rechargeable lithium ion batteries comprising dedicated positive electrode active materials. In particular, this invention describes lithium transition metal oxide compounds as positive electrode materials with a specific composition and crystallite size, to be used in rigid batteries. This application enhances the battery performances, such as long-term cycle stability, even at a high voltage and high temperature.

LiCoO₂ (doped or not—hereafter referred to as “LCO”) has been generally used as a positive electrode active material for lithium ion batteries (LIBs). However, LCO is not sustainable for large batteries needed in EVs and HEVs due to many reasons. First, LCO has a low capacity at a relatively low voltage. It is possible to use LCO up to 4.4V, but it requires higher standard battery technologies regarding the electrolyte and the separator. Second, LCO is not safe due to the low onset temperature of the reaction with an electrolyte. It becomes even less safe when being used in high voltage cells. Third, cobalt resources are limited—as approximately 41% of global cobalt demand in 2015 was used for the battery industry, according to the Cobalt Development Institute. Therefore, new positive electrode materials with high theoretical capacity and cycle stability have been developed. Using LCO as starting point, by metal substitution, i.e. replacing Co by other transition metals, lithium nickel cobalt manganese-based oxide (hereafter referred to as “NMC”) and lithium nickel cobalt aluminum-based oxide (hereafter referred to as “NCA”) have been suggested as alternatives for LIBs. Especially, NMC compounds are relatively cheaper and have a higher capacity at higher voltage. However, as the Ni content of a NMC composition increases, its safety is becomes quite poor. The state of the art NMC, high Ni NMC, and very high Ni NMC compounds are powders comprised of dense secondary particles, usually of spherical shape, comprising small primary particles, and having the general formula Li₁₊ₐ[Ni_{z}(Ni_{0.5}Mn_{0.5})_{y}Coₓ]₁₋ₐO₂. Here, the definition of high Ni NMC is an NMC with a Ni-excess (1−x−y, referred as “z”) of at least 0.4 but less than 0.7. The very high Ni NMC is defined as an NMC of which z is at least 0.7. NCA is a lithium nickel-cobalt-aluminum oxide with the general formula

Li₁₊ₐ(Ni_{1-x′-y}Co_{y}Al_{x′})₁₋ₐO₂.

An ideal positive electrode material for large batteries that works safely over a long time should have a high gravimetric energy density (in Wh/g) at relatively low cell voltage. Theoretically, increasing the Ni content in the positive electrode material improves the capacity of the positive electrode active material. However, the higher the Ni content of the positive electrode material, the more difficult it is to produce, and the more difficult it is to use in LIBs. For example, with increasing Ni content, in the manufacturing process of positive electrode material it becomes more and more difficult to reach 100% lithiation. On the surface of a final product unreacted lithium (Li) forms surface impurities such as LiOH and Li₂CO₃ during post treatment. In full cell application, these impurities may decompose at high operating voltage or may react with the electrolyte. Both reactions generate a gas phase, leading to (1) insufficient amount of electrolyte and (2) gas accumulation inside, and eventually swelling of the flexible housing of a full cell. As a consequence, full cell electrodes or separators can be easily detached from electrolyte, resulting in fast capacity fading.

One straightforward solution is to remove the surface impurities of freshly made very high Ni positive electrode materials by washing in distilled water, followed by a drying process and a heat treatment. This washing and drying process is feasible at industrial scale but comes with an additional production cost. However, the washing process not only removes the residual Li on the surface of the positive electrode material, but also leads to a significant amount of Li ion exchange with water. It happens on the very surface of the positive electrode materials and also at the grain boundaries between primary particles. The former leads to a passivated (Li depleted) layer with less Li ion conductivity during charge and discharge. The latter results in weakened grain boundaries, and due to the intrinsic cell volume expansion and shrinkage during cycling it then becomes easier to have intergranular cracking. As a result, the washed and dried positive electrode material has a worse cycle stability than the non-washed one.

Another way to reduce surface impurities is to lithiate and sinter the positive electrode material at a higher temperature. In general, higher temperature treatment results in a more complete lithiation reaction and hence less unreacted Li impurities on the surface.

However, heat treatment at higher temperatures also results in a more intensely sintered product, and as more primary crystal growth occurs this creates brittle secondary particles. Additionally, very high Ni positive electrode materials sintered at high temperature tend to crack more during electrode calendaring, which is a roll press step to compact the components of the electrode. Micro-scale cracks induced in this step increase the total surface area, which is not preferred because undesired side reactions between the electrolyte and the positive electrode material can take place. On the other hand, micro cracks are difficult to wet by the electrolyte, resulting in poor rate performance or even non-accessible areas for Li extraction and intercalation. Both are reasons for inferior cycle stability. Therefore, an ideal positive electrode active material should not be sintered at a higher temperature than an optimum reaction temperature that is a compromise taking into account the previous reasoning.

An alternative way to control the residual surface impurities is to coat the surface of positive electrode materials with certain elements that can easily react with residual Li, such as B, P, F, Al etc. Coating of the positive electrode material is widely applied in industry. However, coating requires an additional blending of the positive electrode material with coating sources followed by a firing process, which increases the production cost. In addition, excessive coating is not preferred due to capacity reduction whereas insufficient coating can lead to an inhomogeneous coating. Therefore, the coating strategy at industrial scale is not so straightforward.

Compromising on throughput in the production may also be helpful to make very high Ni positive electrode material with less residual Li impurities on the surface at a target sintering temperature. For example, in the typical roller hearth kiln (RHK) applied in positive electrode material production, the loading amount in a tray (or sagger) can be reduced to ensure a proper gas exchange for a better complete lithiation. Hence, the remaining unreacted Li impurities is suppressed. However, reducing the tray load decreases the throughput, evidently leading to a higher providing cost of production.

In summary, it is difficult to produce a very high Ni positive electrode material having good cycling performance at low cost at an industrial scale. Therefore this invention aims at defining alternative battery designs and compositions that allow to discard certain measures during the production process of very high Ni positive electrode material that negatively influence the cost of production and/or the electrochemical performance of the battery.

### SUMMARY

Viewed from a first aspect, the invention can provide a secondary Li-ion battery comprising a casing comprising as battery parts:
a positive electrode comprising a powderous positive electrode active material,
a negative electrode,
a separator, and
an electrolyte,

wherein the casing is provided with means for maintaining a predetermined exterior form of the casing, said predetermined exterior form allowing to ensure a permanent contact between the battery parts when the battery is in use and when a pressure of preferably at least 500 kPa exercised from inside the casing is generated during said use, and wherein the positive electrode active material has the general formula Li₁₊ₐ(NiₓCo_{y}M_{z})₁₋ₐO₂, wherein M=M′_{1-b}A_{b}, M′ being either one or both of Al and Mg, and A being a dopant with b≤0.10, and wherein −0.03≤a≤0.03, 0.80≤x≤0.95, 0.05≤y≤0.20, z≤0.10, with x+y+z=1, and wherein the positive electrode active material has a crystallite size ≤43 nm as determined by the Sherrer equation based on the peak of the (104) plane obtained from the X-ray diffraction pattern using a Cu Kα radiation source, and wherein the positive electrode active material further comprises between 0.40 and 0.75 wt % LiOH. When such a positive electrode active material is cycled in the battery, there will be formation of gas and an internal build-up of pressure in the cell, and therefore the casing of the cell is adapted to permanently withstand this pressure. From the prior art, such as Louli et al. in “Volume, Pressure and Thickness Evoluition of Li-Ion Pouch Cells with Silicon-Composite Negative Electrodes”, Journal of The Electrochemical Society, 164 (12) A2689-A2696 (2017), it is known that “rigid” would be equivalent to being able to withstand a pressure of 50N/cm² (5 bar or 500 KPa) without being permanently deformed, which is a pressure that is known to build up inside the cell during cycling. The rigid battery will however normally be able to handle even higher pressures without being permanently deformed, such as 80N/cm² or 8 bar.

In the formula Li₁₊ₐ(NiₓCo_{y}M_{z})₁₋ₐO₂,
if “a” is more than 0.03, the Li/M′ stoichiometric ratio exceeds 1.062, increasing the content of surface impurities and deteriorating the cycle life,
if “a” is less than −0.03, the Li/M′ stoichiometric ratio is less than 0.942, deteriorating the capacity and cycle stability.

Therefore, in this invention, the lithium to transition metal molar ratio Li/M′ is between 0.942 and 1.062 (corresponding to −0.03≤a≤0.03). In an embodiment “a” is between −0.005 and −0.010, and thus the Li/M′ stoichiometric ratio is less than 1.00 (between 0.98 and 0.99), resulting in an appropriate amount of surface impurities and good electrochemical properties. In another embodiment the positive electrode active material has a crystallite size between 30 and 43 nm. If the crystallite size is less than 30 nm, the capacity of the positive electrode active material decreases because the material is not crystalline enough. In still another embodiment 0≤z≤0.03, in order to prevent that the capacity is lowered too much. In an alternative embodiment, the formula of the positive electrode active material is Li₁₋ₐ(NiₓCo_{y}Al_{z})₁₋ₐO₂, wherein −0.03≤a≤0.03, 0.80≤x≤0.90, 0.10≤y≤0.20, and either z=0 or 0.02≤z≤0.05, with x+y+z=1. In different embodiments, the dopant A may be either one or more of Ti, B, Ca, Ga and Nb. It may be advantageous that the powderous positive electrode active material has a particle size distribution with a D50 between 10 to 15 μm, since this may provide the advantages of a high tap density, a high energy density, a good particle strength, etc. It is difficult to have a D50 value above 15 μm, since therefore a coarse transition metal precursor would be needed—typically a transition metal (oxy-)hydroxide—that is difficult to prepare.

This invention provides a lithium ion battery comprising a very high Ni positive electrode material that has excellent electrochemical properties such as long-term cycle stability even at a high voltage and high temperature. In an embodiment the battery comprises either a rigid casing that is able to withstand a pressure exercised from inside the casing, or a flexible casing whereupon pressure is applied to ensure a permanent contact between the battery parts. In different embodiments the battery may be either a cylindrical 18650, 20700, 21700, 22700, 26650 or 26700 lithium-ion cell, whereby the battery also may be incorporated in a pack of multiple batteries. The battery may also be a hard-case prismatic lithium-ion cell.

In a preferred embodiment of the present invention, the battery parts are included in a sealed flexible container having an expandable volume, said container being lodged in an inner space of the casing, said inner space being defined by at least two different wall sections of the casing which are opposed to each other, said wall sections being connected to one another by said means for maintaining a predetermined exterior form of the casing, said wall sections and means for maintaining a predetermined exterior form of the casing being sufficiently rigid so as to allow the casing to withstand a pressure resulting from an expansion of the volume of the sealed container when the battery is used, thereby ensuring a permanent contact between the battery parts, said pressure being preferably of at least 500 kPa, and more preferably of maximum 800 KPa.

In an alternative embodiment of the present invention, the battery parts are included in a sealed flexible container having an expandable volume, said container being lodged in an inner space of the casing, said inner space being defined by at least two different wall sections for the casing which are opposed to each other, said wall sections being connected to one another by said means for maintaining a predetermined exterior form of the casing, each of or both of at least one wall section and said means for maintaining a predetermined exterior form of the casing being flexible, the casing comprising means for applying a pressure on each of or both of said wall sections and said means for maintaining a predetermined exterior form of the casing, so as to ensure a permanent contact between the battery parts, said pressure being preferably of at least 500 kPa, and more preferably of maximum 800 KPa.

Viewed from a second aspect, the invention provides a method for preparing the secondary Li-ion battery according to any one of the embodiments mentioned before, the method comprising the steps of:

A) providing a positive electrode comprising a powderous positive electrode material,

B) providing a negative electrode,

C) providing an electrolyte,

D) providing a separator, and

E) assembling the materials provided in steps A) to D) in a casing, wherein the casing is provided with means for maintaining the exterior form of the casing when the battery is in use, and wherein step A) comprises the following substeps for providing the powderous positive electrode material:

a) providing either a metal hydroxide or a metal oxyhydroxide comprising Ni and Co, and being prepared by the co-precipitation of metal salts with a base, and

b) when z>0, providing a precursor compound comprising either one or both of Mg and Al,

c) mixing the compounds of steps a) and b) with either one of LiOH, Li₂O and LiOH—H₂O, and

d) heating the mixture of step c) at a temperature between 700 and 750° C. under oxygen.

In this method, it may be that the metal hydroxide or the metal oxyhydroxide comprising Ni, Co further comprises A. Also the precursor compound comprising either one or both of Mg and Al may be an oxide of either one or both of Mg and Al, for example Al₂O₃ or MgO.

Viewed from a third aspect, the invention can provide the use of the secondary Li-ion battery in any one of its embodiments described in the first aspect of the invention in a battery pack of an electric vehicle or a hybrid electric vehicle. It may be that this battery pack is cycled between at least 2.50V and at most 4.5V at a charging/discharging rate of at least 0.8 C/0.8 C. Also, it may be that the battery has a 80% retention capacity after at least 1000 cycles at a 1 C charge/1 C discharge rate. There are many possibilities for the voltage range of such a battery pack, for example it may be cycled between either one of 2.7V and 4.2V, 2.7V and 4.3V, 2.7V and 4.35V, and 2.7V and between 4.4V and 4.5V.

### BRIEF DESCRIPTION OF THE DRAWINGS

FIG. 1. Schematic drawing of battery test “B1: Clamping cell”

FIG. 2. Full cell testing results of EEX1.1 to EEX1.3 for a range of 2.7 to 4.2V at 25° C. and 45° C.,

FIG. 3.1. Full cell testing results of EEX2.1 to EEX2.6 for a range of 2.7 to 4.2V at 25° C.,

FIG. 3.2. Full cell testing results of EEX2.1 to EEX2.6 for a range of 2.7 to 4.2V at 45° C.,

FIG. 4. Bulging test results of EEX1.1 to EEX1.3 and EEX2.1 to EEX2.6,

FIG. 5.1. Full cell testing results of EX1 and CEX1 at the range of 2.7 to 4.2V at 45° C.,

FIG. 5.2. Full cell testing results of CEX2.1 to CEX2.4 at the range of 2.7 to 4.2V at 45° C.,

FIG. 5.3. Full cell testing results of EX1 and CEX1 at the range of 2.7 to 4.3V at 45° C.,

FIG. 6. Full cell testing results of EX2, CEX3, and CEX4 at the range of 2.7 to 4.2V at 45° C.,

FIG. 7. Full cell testing results of EX3, CEX5, and CEX6 at the range of 2.7 to 4.2V at 45° C.,

FIG. 8. Full cell testing results of EX4.1, EX4.2, CEX7.1, and CEX7.2 at the range of 2.7 to 4.2V at 45° C.,

FIG. 9. Full cell testing results of EX5.1, EX5.2, CEX8.1, and CEX8.2 at the range of 2.7 to 4.2V at 45° C.

### DETAILED DESCRIPTION

Very high Ni positive electrode active material is commercially used in EVs and HVEs batteries. As an example, Tesla's current batteries contain cells with NCA as a positive electrode material. These batteries have a sufficient cycle life for several reasons.

First, it takes a few hours to fully charge the Tesla battery because the charge-discharge reaction is slow. With a mileage of several hundred kilometers, it will take many hours for the battery to discharge. This is different from typical portable electronic devices like laptops or mobile phones that are charged and discharged at faster rates, and a charge-discharge test is usually performed at 1 C/1 C rate (1 hr for full charge/1 hr for full discharge). Compared to this rate, a Tesla battery has a much slower charge-discharge rate, resulting in a more stable cycling of the battery.

Second, the Tesla battery does not have to survive thousands of cycles. As an extreme example—if we aim for a lifetime mileage of 300,000 km (exceeding the typical use of a car), a mileage of 300 km between two charges (which is much less than that of Tesla Model S) corresponds to 1000 full charge-discharge cycles over the car's total life. Therefore, a battery life of 500 cycles may actually be sufficient, where the battery life theoretically ends when there is less than 80% retention capacity left.

Finally, a Tesla battery operates the cells under mild conditions. The charge does not exceed 4.1V per cell whereas portable applications are now charged to 4.35V, 4.40V or even 4.45V per cell.

In the future, different types of batteries may be needed. These batteries should be smaller—thus providing a shorter drive range but requiring to allow for fast charging. These batteries are thus effectively cycled at faster rate and need to survive more charge-discharge cycles. To increase the energy density, the charging voltage should be increased to 4.20V, 4.25V or even 4.50V. A typical battery requirement would be to perform at least 2000 cycles at 1 C/1 C rate with at least 80% of the initial energy density remaining after 2000 cycles. If a state of the art present day Tesla battery is cycled under such conditions, it shows a much poorer cycle life. It is expected that the currently applied positive electrode material itself does not allow at all to achieve a capacity retention of more than 80% after 2000 cycles at 1 C/1 C rate.

The current invention focuses on batteries with improved cycle stability, using charging voltages of 4.20V or more and targeting thousands of cycles at fast 1 C/1 C rate. These batteries contain a type of cell referred as “fast-charging cell”. The inventors have been looking into the possibility to achieve high capacity and good cycle life in such a fast-charging cell using a positive electrode material with a very high Ni content. The conclusions can be summarized in a simple way as follows:

1) State of the art positive electrode materials with a very high Ni content do not allow to achieve good cycle life in the fast-charging battery. The reason is an inherent deterioration of the battery often caused by cracks in the positive electrode particles. These particles do not contribute to the reversible capacity anymore as they are disconnected from other particles.

2) The positive electrode material with a very high Ni content and a low crystallinity of this invention shows a poor capacity retention in a standard flexible pouch cell used during performance testing. Since very high Ni positive electrode materials with a low crystallinity are prepared at a lower sintering temperature, this is likely to lead to a high amount of remaining Li impurities which affect gas creation and swelling of the battery.

3) Surprisingly however, the fading mechanism is not attributable to particle cracking, but rather to a loss of active Li and damage to the negative electrode material. Post-mortem analysis show that the positive electrode material itself still has near 100% of reversible capacity.

4) A careful investigation of the damage of the negative electrode material shows that the root cause is gas creation in the cell. The generated small gas bubbles block the straight Li diffusion path. Li ions are redirected to the edge of the bubble and more Li is deposited on the negative electrode thereby causing electrolyte side reactions and dynamic Li plating. As a consequence, the electrolyte is reduced by the Li and active Li is consumed.

5) Where the prior art attempts to modify the positive electrode material in order to reduce the impurities by washing (as in Journal of Power Sources, 222, 318-325 (2013)) or coating (as in WO2016/116862 and WO2015/128722), etc. this always results in a degradation of the cycle stability of the positive electrode. The present inventors conclude that future batteries should contain very high Ni positive electrode materials that are able to tolerate a high impurity contents, especially a sufficient high content of LiOH.

6) Finally, the very high Ni positive electrode material having a low crystallinity of the current invention achieves enhanced cycling performances under mechanical pressure. For example, when pressure is applied during cycling of a pouch cell, gas bubbles are squeezed out to the inside wall of the cell and no longer block the Li diffusion path between the positive and negative electrodes. Accordingly a rigid type sealed cell or battery comprising a case or container resisting a pressure build-up inside the cell shows the desired long-term cycle stability.

A rigid cell means a cell having a hard-case or a cell whereupon pressure is applied that ensures a good contact between the battery parts. Here are examples for such rigid cell:

1) A cylindrical hard-case battery with internally a wound jelly roll. The diameter of the prepared jelly roll is between 0.5 and 1 mm smaller than the inside diameter of the battery's steel can, but the cell parts—mainly positive and negative electrodes—are swollen and increase the jelly diameter during cycling. The deformation of the battery by the increased jelly roll diameter can be controlled through the can. This can material is made of stainless steel, aluminum, and etc. Cylindrical cells contain a pressure relief mechanism.

2) A similar system is applied in hard-case prismatic cells of various geometrical shapes that contain flat-wound electrodes.

3) Button or coin type of batteries have a metal bottom body and top cap. The battery case endures the inside pressure occuring during cycling. The case material generally is made of stainless steel.

4) Gas and electrode deformation can also be easily controlled in a prismatic or polymer pouch type of batteries having a flexible housing, by using a clamping technique with a rigid plate. As disclosed in U.S. Pat. No. 9,620,809, a clamping device comprising plates and a compressible elastic member is configured to reduce deformation of an electrode in the battery upon charging. When the pouch type of full cell is placed between plates with fixed distance in the clamping device, gas generation induced swelling in the battery is suppressed, resulting in the battery maintaining its electrochemical properties. It is an efficient and simple way to retain the initial performance of cells. In this invention, the clamping device is comprised of rigid plates and compression tools, such as a screw, for applying pressure to the prismatic and polymer type of batteries. This device helps to maintain good contact between cell parts against gas and electrode distortion.

Therefore, in this invention, the very high Ni positive electrode material with an optimal crystallite size is prepared and applied in a cell having means to maintain the original exterior form of the battery, such as a cell having a rigid casing made of metal. As a result, an enhanced electrochemical performance such as the long-term cycle life is achieved at a high temperature and high cut-off voltage operation.

The following analysis methods are used in the Examples:

A) X-ray diffraction measurement

The X-ray diffraction pattern of the positive electrode material is collected with a Rigaku X-Ray Diffractometer (Ultima IV) using a Cu Kα radiation source (40 kV, 40 mA) emitting at a wavelength of 1.5418 Å. The instrument configuration is set at: a 1° Soller slit (SS), a 10 mm divergent height limiting slit (DHLS), a 1° divergence slit (DS) and a 0.3 mm reception slit (RS). The diameter of the goniometer is 158 mm. For the XRD, diffraction patterns are obtained in the range of 15-85° (2θ) with a scan speed of 1° per min and a step-size of 0.02° per step. The crystallite sizes are calculated from the diffraction angle and the full width at half maximum (FWHM) of the peak of the (104) plane obtained from the X-ray diffraction pattern using the known Scherrer equation:

$$D = \frac{K λ}{β cos θ}$$

D: Crystallite size (nm)

K: Scherrer constant, 0.9

λ: X-ray wavelength (CuKα=1.542 Å)

β: FWHM

θ: XRD peak position, one half of 20

The peak of (104) plane assigned to a crystal structure with space group R-3m is observed at (around) 44.5±1° in the X-ray diffraction pattern.

B) pH titration test

The soluble base content, which means basic type Li impurities on the surface of the final product, is a material surface property that can be quantitatively measured by the analysis of reaction products between the surface and water, as is described in WO2012-107313. If powder is immersed in water, a surface reaction occurs. During the reaction, the pH of the water increases (as basic compounds dissolve) and the base content is quantified by a pH titration. The result of the titration is the “soluble base content” (SBC). The content of soluble base can be measured as follows: 4.0 g of powder is immersed into 100 ml of deionized water and stirred for 10 mins in a sealed glass flask. After stirring to dissolve the base, the suspension of powder in water is filtered to get a clear solution. Then, 90 mL of the clear solution is titrated by logging the pH profile during addition of 0.1 M HCl at a rate of 0.5 ml/min under stirring until the pH reaches 3. A reference voltage profile is obtained by titrating suitable mixtures of LiOH and Li₂CO₃ dissolved in low concentration in DI water. In almost all cases, two distinct plateaus are observed in the profile. The upper plateau with endpoint γ1 (in mL) between pH 8-9 is the equilibrium OH⁻/H₂O followed by the equilibrium CO₃²⁻/HCO₃⁻, the lower plateau with endpoint γ2 (in mL) between pH 4-6 is HCO³⁻/H₂CO₃. The inflection point between the first and second plateau γ1 as well as the inflection point after the second plateau γ2 are obtained from the corresponding minima of the derivative dₚₕ/d_{Vol} of the pH profile. The second inflection point generally is near to pH 4.7. Results are then expressed in LiOH and Li₂CO₃ weight percent as follows:

$${Li}_{2} {CO}_{3} wt \% = \frac{73.890 \; 9}{1000} \times ( {γ}_{2} - {γ}_{1} ) ; LiOH wt \% = \frac{23.948 \; 3}{1000} \times ( 2 \times {γ}_{1} - {γ}_{2} ) .$$

C) Full cell testing

C1) Full cell preparation

650 mAh (flexible) pouch-type cells are prepared as follows: the positive electrode material, Super-P (Super-P, Timcal), graphite (KS-6, Timcal) as positive electrode conductive agents and polyvinylidene fluoride (PVDF 1710, Kureha) as a positive electrode binder are added to N-methyl-2-pyrrolidone (NMP) as a dispersion medium so that the mass ratio of the positive electrode active material powder, positive electrode conductive agents (super P and graphite) and the positive electrode binder is set at 92/3/1/4. Thereafter, the mixture is kneaded to prepare a positive electrode mixture slurry. The resulting positive electrode mixture slurry is then applied onto both sides of a positive electrode current collector, made of a 15 μm thick aluminum foil. The width of the applied area is 43 mm and the length is 406 mm. The typical loading weight of a positive electrode active material is about 11.5±0.2 mg/cm². The electrode is then dried and calendared using a pressure of 120 kgf (1176.8 N) to an electrode density of 3.3±0.05 g/cm³. In addition, an aluminum plate serving as a positive electrode current collector tab is arc-welded to an end portion of the positive electrode.

Commercially available negative electrodes are used. In short, a mixture of graphite, carboxy-methyl-cellulose-sodium (CMC), and styrenebutadiene-rubber (SBR), in a mass ratio of 96/2/2, is applied on both sides of a 10 μm thick copper foil. A nickel plate serving as a negative electrode current collector tab is arc-welded to an end portion of the negative electrode. A typical loading weight of a negative electrode active material is 8±0.2 mg/cm². Non-aqueous electrolyte is obtained by dissolving lithium hexafluorophosphate (LiPF₆) salt at a concentration of 1.0 mol/L in a mixed solvent of ethylene carbonate (EC), ethylmethyl carbonate (EMC), diethyl carbonate (DEC) in a volume ratio of 1:1:1.

A sheet of positive electrode, negative electrode, and a separator made of a 20 μm thick microporous polymer film (Celgard® 2320, Celgard) interposed between them are spirally wound using a winding core rod in order to obtain a spirally-wound electrode assembly. The assembly and the electrolyte are then put in an aluminum laminated pouch in a dry room with dew point of −50° C., so that a flat pouch-type lithium secondary battery is prepared. The design capacity of the secondary battery is 650 mAh when charged to 4.2V or 4.3V. The non-aqueous electrolyte solution is impregnated for 8 hours at room temperature. The battery is pre-charged to 15% of its expected capacity and aged for a day at room temperature. The battery is then degassed and the aluminum laminated film pouch is sealed. The battery is prepared for use as follows: the battery is charged using a current of 0.2 C (with 1 C=630 mA) in CC mode (constant current) up to 4.2V or 4.3V, then in CV mode (constant voltage) until a cut-off current of C/20 is reached, before the discharge in CC mode at 0.5 C rate, down to a cut-off voltage of 2.7V.

C2) Cycle life test

The prepared full cell battery is charged and discharged several times under the following conditions at 25° C. and 45° C. to determine the charge-discharge cycle performance:
Charging is performed in CC mode under 1C rate up to 4.2V or 4.3V, then CV mode until C/20 is reached,
The cell is then set to rest for 10 minutes,
The discharge is done in CC mode at 1C rate down to 2.7V,
The cell is then set to rest for 10 minutes,
The charge-discharge cycles proceed until the battery reaches 80% retained capacity.

Every 100 cycles, one discharge is done at 0.2C rate in CC mode down to 2.7V.

If 80% retained capacity is not reached by the end of the normal number of cycles, an expected cycle number to obtain 80% retained capacity is calculated by a linear trend line.

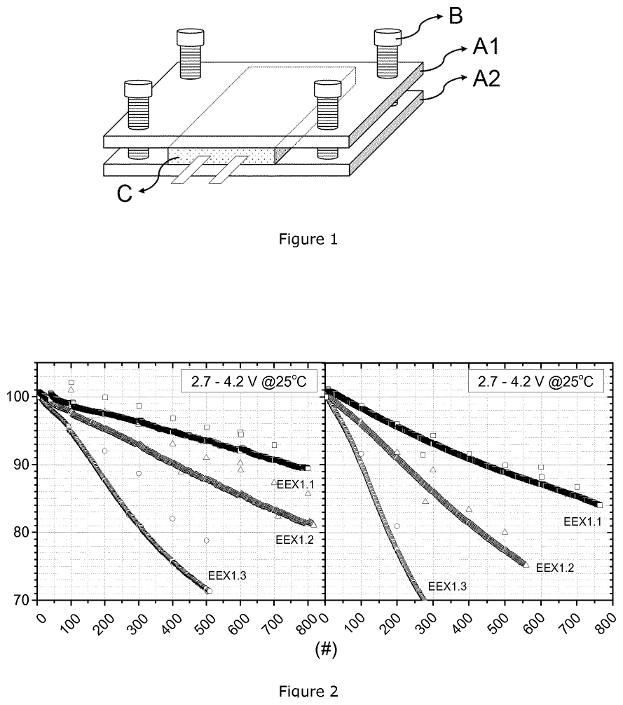

In certain examples in this invention, the above-mentioned full cell testing is performed on a rigid cell, i.e. a cell where either pressure is applied on a flexible pouch (as prepared in C1)) or a known cylindrical type of batteries, in order to suppress swelling induced by gas creation in the battery. For the cell where pressure is applied, a so-called clamping cell is used, comprising two stainless steel plates, where a pouch cell is placed between the plates to apply pressure on the cell using a screw. As shown in FIG. 1, the rigid plates (A1 and A2) provide the constant thickness using a screw (B) during usage of a pouch type of battery (C). Hereafter the test in such a “clamped” pouch type of battery is referred to as “B1: Clamping cell”. The cylindrical type of battery is referred to as “B2: Cylindrical cell”. For the counterexamples, a flexible battery test without externally exercised pressure is referred to as “B3: Standard pouch cell”.

C3) Bulging test

650 mAh pouch-type batteries prepared by above preparation method are fully charged until 4.2V and inserted in an oven which is heated to 90° C., then stays for 4 hours. At 90° C., the charged positive electrode reacts with an electrolyte and creates gas. The evolved gas creates a bulging. The increase of thickness ((thickness after storage-thickness before storage)/thickness before storage) is measured after 4 hours.

The invention is further exemplified in the examples below. Note that besides NMC and NCA also NC and NCX are prepared, where NC stands for Li₁₊ₐ(Ni_{1-y}Co_{y})₁₋ₐO₂ and NCX for a dopant added to the NiCo.

### EXPLANATORY EXAMPLE 1

The explanatory examples are investigating electrochemical properties in standard pouch full cells (B3 type) comprising positive electrode materials with different crystallite sizes. An NMC powder, having the formula Li₁₊ₐ(Ni_{0.2}(Ni_{0.5}Mn_{0.5})_{0.6}Co_{0.2})₁₋ₐO₂, where (1+a)/(1−a) represents the Li/M′ stoichiometric ratio, is obtained through a direct sintering process which is a solid state reaction between a lithium source and a mixed transition metal source as follows:

1) Co-precipitation: a mixed metal hydroxide precursor M′O_{0.32}(OH)_{1.68} with metal composition M′=Ni_{0.2}(Ni_{0.5}Mn_{0.5})_{0.6}Co_{0.2} is prepared by a co-precipitation process in a large-scale continuous stirred tank reactor (CSTR) with mixed nickel-manganese-cobalt sulfates, sodium hydroxide and ammonia.

2) Blending: the mixed transition metal precursor and Li₂CO₃ as a lithium source are homogenously blended at a Li/M′ ratio of 1.05 in an industrial blending equipment for 30 minutes.

3) Sintering: The above blend is lithiated and sintered at 900° C. for 10 hours under an oxygen containing atmosphere in a roller hearth kiln (RHK).

4) Post treatment: after sintering, the sintered cake is crushed, classified and sieved so as to obtain a non-agglomerated powder.

The NMC compound produced by above steps is labeled ENMC1.1 having as formula Li_{0.964}M′_{1.036}O₂ with M′=Ni_{0.2}(Ni_{0.5}Mn_{0.5})_{0.6}Co_{0.2}. ENMC1.2 and ENMC1.3, both with formula Li_{1.024}M′_{0.976}O₂ with M′=Ni_{0.2}(Ni_{0.5}Mn_{0.5})_{0.6}Co_{0.2}, are prepared using the same method as in ENMC1.1, except that the sintering temperature is 915° C. and 930° C. respectively.

To investigate the crystallinity of the NMC compounds depending on the sintering temperature, ENMC1.1 to ENMC1.3 are analyzed by method A). In this analysis, the crystallite sizes are calculated by Scherrer equation using the peak of (104) plane at (around) 44.5±1° in the X-ray diffraction pattern. The amount of Li impurities of the examples is analyzed by method B). The electrochemical performance of the examples are also evaluated by method C2). The full cell testing is performed using a “B3: Standard pouch cell” in the range of 4.2 to 2.7V at 25° C. and 45° C. For the analysis, battery are labelled as EEX1.1 to EEX1.3. The crystallite size, amount of LiOH and Li₂CO₃ as Li impurities and full cell testing results of ENMC1.1 to ENMC1.3 are shown in Table 1.

TABLE 1
Properties of Examples EEX1.1-1.3

| | Positive | | Sintering | | | | | Cycle# | Cycle# |
|---|---|---|---|---|---|---|---|---|---|
| Battery | electrode | Li/M′ | Temp | CS | LiOH | Li₂CO₃ | Bulging | 80% | 80% |
| ID | ID | ratio | (° C.) | (nm) | (wt %) | (wt %) | (90° C.) | (25° C.) | (45° C.) |
| EEX1.1 | ENMC1.1 | 0.93 | 900 | 41.0 | 0.120 | 0.110 | 19.4 | 1485 | 922 |
| EEX1.2 | ENMC1.2 | 1.05 | 915 | 44.3 | 0.091 | 0.171 | 18.7 | 830 | 434 |
| EEX1.3 | ENMC1.3 | 1.05 | 930 | 45.9 | 0.075 | 0.141 | 11.6 | 315 | 177 |

“CS” means Crystallite size
“Bulging” means the thickness increase (%) after bulging test C3)
“Cycle# 80%” means the number of cycles before the 80% was reached, as explained in C2)

As shown in Table 1, the crystallite size increases with increasing the sintering temperature, whilst the Li impurities, especially LiOH, decrease. The full cell cycle life shows there is a correlation between full cell cycle stability and crystallite size both at 25° C. and 45° C. cycling, as shown in FIG. 2 (x-axis: number of cycles #; y-axis: relative discharge capacity (in %), being the discharge capacity at cycle # divided by the initial discharge capacity and multiplied by 100) and Table 1. Therefore, an NMC sintered at a lower temperature with lower crystallite size ensures long-term cycle stability in the full cell.

### EXPLANATORY EXAMPLE 2

In this explanatory example the electrochemical properties of a standard pouch type cell are investigated and correlated with an amount of Al or Mg doping. An NC powder, having the formula Li₁₋ₐ(Ni_{0.85}Co_{0.15})₁₋ₐO₂, where (1+a)/(1−a) represents the Li/M′ stoichiometric ratio, is obtained by the same method as in ENMC1.1, except that the mixed metal hydroxide precursor is M′O_{0.17}(OH)_{1.83} with metal composition M′=Ni_{0.85}Co0.15. In the blending step, the mixed transition metal precursor and LiOH.H₂O as a lithium source are homogenously blended at a Li/M′ ratio of 0.98. The blend is lithiated and sintered at 795° C. for 10 hours under an oxygen containing atmosphere in a RHK.

The final NC product is labeled ENC1.1, having as formula Li_{0.99}M′_{1.01}O₂ with M′=Ni_{0.85}Co_{0.15}. ENC1.2 to ENC1.4 are prepared using the same method as in ENC1.1, except that aluminum oxide (Al₂O₃) as a dopant source is added during the blending step, resulting in NCA. The amounts of Al doping (in mol %) of the examples—where the total metal elements (Ni, Co and Al) of the final product are set to 100 mol %—are given in Table 2.

ENC1.5 and ENC1.6 are also prepared using the same method as in ENC1.1, except that magnesium oxide (MgO) is added as a dopant source during the blending step. The amounts of Mg doping (in mol %)—where the total metal elements (Ni, Co and Mg) of the final product are set to 100 mol %—are given in Table 2.

The crystallite size, Li impurities and electrochemical performance of ENC1.1 to ENC1.6 are evaluated by the same method as in Explanatory Example 1. For the analysis, batteries are labelled as EEX2.1 to EEX2.6. These analysis results are shown in Table 2.

TABLE 2
Properties of Examples EEX2.1 to 2.6

| | Positive | | | | | | Cycle# | Cycle# |
|---|---|---|---|---|---|---|---|---|
| Battery | electrode | | CS | LiOH | Li₂CO₃ | Bulging | 80% | 80% |
| ID | ID | Dopant | (nm) | (wt %) | (wt %) | (90° C.) | (25° C.) | (45° C.) |
| EEX2.1 | ENC1.1 | — | 47.1 | 0.286 | 0.242 | 57.1 | 723 | 324 |
| EEX2.2 | ENC1.2 | 2 mol % Al | 45.3 | 0.304 | 0.244 | 47.1 | 1592 | 591 |
| EEX2.3 | ENC1.3 | 4 mol % Al | 42.3 | 0.340 | 0.220 | 55.7 | 2277 | 743 |
| EEX2.4 | ENC1.4 | 6 mol % Al | 40.8 | 0.402 | 0.241 | 77.9 | 2224 | 842 |
| EEX2.5 | ENC1.5 | 2 mol % Mg | 47.9 | 0.343 | 0.385 | 53.6 | 810 | 307 |
| EEX2.6 | ENC1.6 | 4 mol % Mg | 47.3 | 0.322 | 0.537 | 52.0 | 919 | 330 |

Very high Ni positive electrode materials contain higher amounts of surface impurities compared to the relatively low Ni positive electrode materials, such as ENMC1 having as formula Li₁₊ₐ(Ni_{0.2}(Ni_{0.5}Mn_{0.5})_{0.6}Co_{0.2})₁₋ₐO₂.

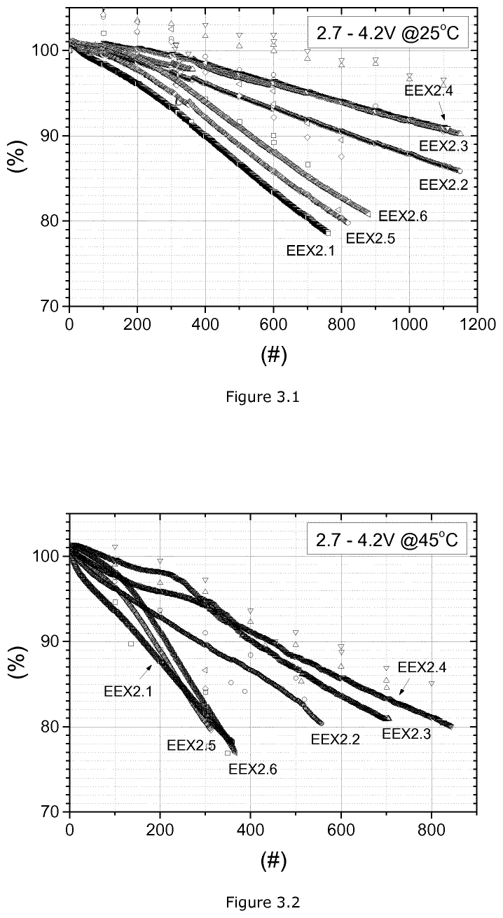

As shown in Table 2, although these doped and non-doped NC products are sintered at a much lower temperature than in ENMC1.1 to ENMC1.3, their crystallite sizes are in the similar range as those of ENMC1.1 to ENMC1.3. With increasing Al doping amount, the crystallite size decreases. For Al doped NC products, full cell cycle life in “B3: standard pouch cell” also confirms a similar trend as in Explanatory Example 1—better cycle stability with smaller crystallite size for both at 25° C. and 45° C., as shown in FIGS. 3.1 and 3.2 (x-axis: number of cycles #; y-axis: relative discharge capacity (in %), being the discharge capacity at cycle # divided by the initial discharge capacity and multiplied by 100) and Table 2. On the contrary, for Mg doped NC products, Mg doping has no apparent effect on the crystallite size and the cycle life in these standard flexible cells.

The positive electrode active material with a low crystallite size has a larger surface area than that having a larger crystallite size. Residual Li impurities may be higher because of the larger surface area for the Li⁺ exchange. Accordingly, the NC product with a lower crystallite size unavoidably has more surface impurities. This property is related to full cell performance, especially gas creation during cycling.

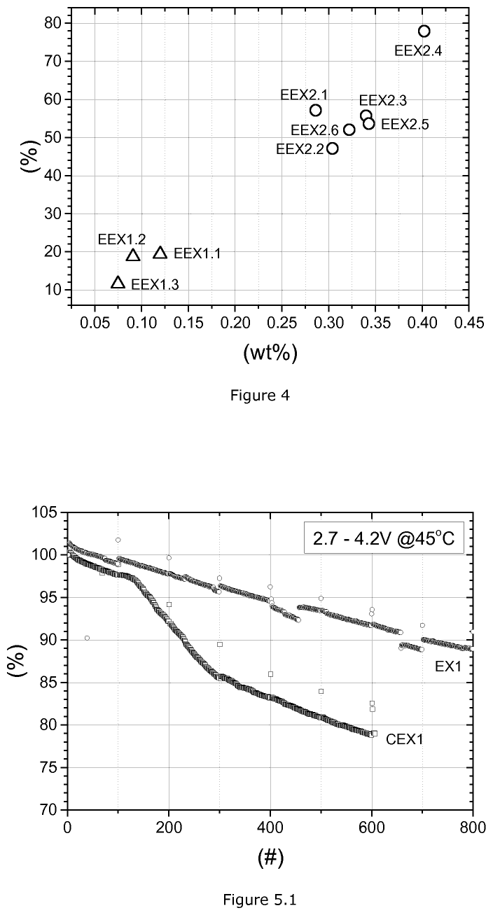

Full cells often produce gas when exposed to high voltage or high temperature operation. One typical test is the full cell bulging test C3), i.e. fully charged full cell is stored in a chamber at 90° C. for 4 hours. After the test, the cell's thickness increase rate can be used as an indicator of the gas amount, which is related to residual surface impurities. FIG. 4 (x-axis: LiOH content (in wt %—measured by pH titration); y-axis: thickness increase (in %) after bulging test), Table 1 and Table 2 show a general trend in NMC and (doped) NC products, in which the higher LiOH content means the higher gas creation during bulging test, leading to higher thicknesses. During cycling, especially operating at 45° C. or with a higher cut-off voltage, the full cell thickness also increases.

The mechanism of gas creation during cycling at 45° C. is similar to that of the bulging test. It is easy to imagine that gas creation and cell thickness increase will lead to detachment of the electrode components. In severe cases, the contact between electrode and electrolyte may also be affected, resulting in fast capacity fading. For example, Li plating on the negative electrode near to gas bubbles is a major reason of degradation of battery properties, because there the local current density is high. Therefore, it is possible to correlate the crystal size with Li impurities, and further with gas generation during cycling. A small amount of surface LiOH, and consequently a small amount of gas could still be endured by the battery.

Note that strange cycling phenomena were not observed when applying the full cell of Explanatory Example 1 (See FIG. 2), but in FIG. 3.2, a zigzag cycling behavior during cycling at 45° C. is observed in EEX2.3 and EEX2.4. In these results, the slope of capacity fading before the 150^{th} cycle and after 500^{th} cycle is almost the same. On the other hand, the slope of capacity fading is clearly different between the 150^{th} and 500^{th} cycle, indicating a different fading mechanism. This phenomena is only observed for examples with higher amounts of LiOH. The intrinsic higher LiOH content creates gas inside the battery when cycling at high temperature or higher cut-off voltage, which deteriorates the cycle stability. It is understood that for standard pouch cells, using high Ni positive electrode material with a low crystallite size is the key to ensure good cycle stability. However, the LiOH content will increase as the crystallite size decreases, resulting in inferior cycle stability and the bulging of a battery. Independently of crystallite size and LiOH content, in a positive electrode material, doping elements such as Al and Mg help to improve the cycle performance since they help to preserve the crystal structure during cycling.

### EXAMPLE 1 AND COMPARATIVE EXAMPLE 1 & 2

An NCA powder, having the formula Li_{0.99}(Ni_{0.833}Co_{0.147}Al_{0.020})_{1.01}O₂, where Li/M′ ratio is 0.98, is obtained through the same method as in ENC1.1, except that Al₂O₃ as a dopant source is added during blending step and the sintering temperature is 750° C. The final NCA product is labeled NC1 having the formula Li_{0.99}(Ni_{0.833}Co_{0.147}Al_{0.020})_{1.01}O₂. CNC1.1 and CNC1.2 are prepared using the same method as in NC1, except that sintering temperatures are 770 and 790° C., respectively.

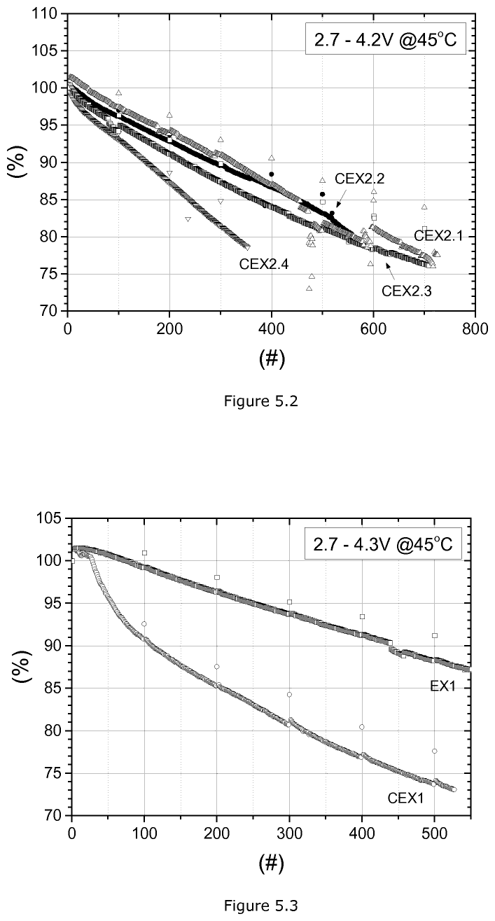

The crystallite size and Li impurities of NC1, CNC1.1 and CNC1.2 are evaluated by the same method as in Explanatory Example 1. These analysis results are shown in Table 3. The full cell testing of EX1 is performed using a “B1: Clamping cell” and “B3: Standard pouch cell” in the range of 2.7 to 4.2 or 4.3V at 45° C. For the cell test type, battery IDs are EX1 and CEX1, respectively. The full cell testing of CNC1.1 and CNC1.2 are performed using a “B1: Clamping cell” and “B3: Standard pouch cell” in the range of 2.7 to 4.2V at 45° C. For the cell test type, battery IDs are CEX2.1 to CEX2.4. These full cell testing results are shown in Table 3 and FIG. 5.1 to FIG. 5.3.

In FIG. 5.1 (x-axis: number of cycles #; y-axis: relative discharge capacity (in %), being the discharge capacity at cycle # divided by the initial discharge capacity and multiplied by 100—the same axis are shown in FIGS. 5.2, 6 & 7), CEX1 which is applied in “B3: Standard pouch cell”, shows the drastic cycle fading after 130^{th} cycles. By preventing the deformation of the flexible cell in the clamping cell (EX1), the cycle fading is suppressed. This effect also occurs during cycling at the high cut-off voltage like 4.3V, as shown in FIG. 5.3. On the other hand, the examples (CEX2.1 and CEX2.2) having a crystallite size larger than 43 nm still have poor cycle stability even in the clamping device, as is also shown in FIG. 5.2.

### EXAMPLE 2 AND COMPARATIVE EXAMPLE 3 & 4

An NC powder, having the formula Li_{0.99}(Ni_{0.85}Co_{0.15})_{1.01}O₂, where Li/M′ ratio is 0.98, is obtained through the same method as in ENC1.1 except that the sintering temperature is 750° C. The final NC product is labeled NC2. CNC2 is prepared using the same method as for NC2, except that the sintering temperature is 770° C. The crystallite size and Li impurities of NC2 and CNC2 are evaluated by the same method as in Explanatory Example 1. These analysis results are shown in Table 3.

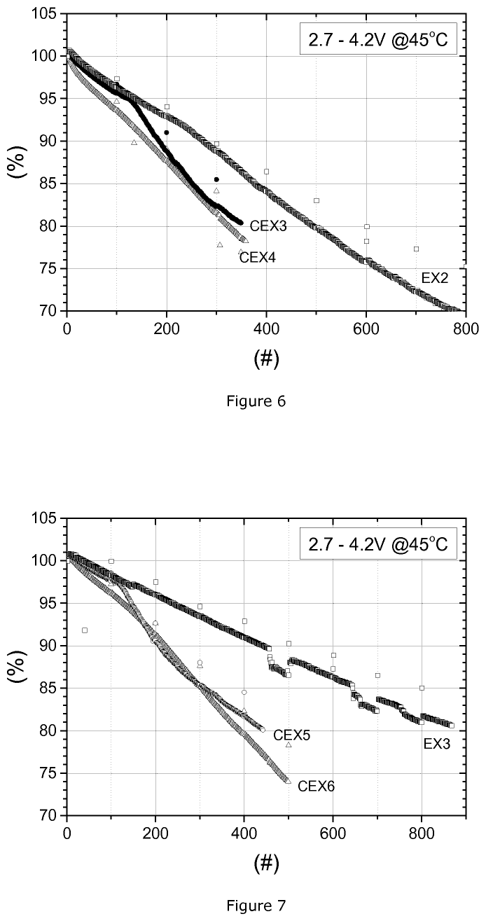

The full cell testing of NC2 is performed using a “B1: Clamping cell” and “B3: Standard pouch cell” in the range of 2.7 to 4.2V at 45° C. For the cell test type, battery IDs are EX2 and CEX3, respectively. The full cell testing of CNC2 is performed using a “B3: Standard pouch cell” in the range of 2.7 to 4.2V at 45° C. For the analysis, battery ID is CEX4. These full cell testing results are shown in Table 3 and FIG. 6.

### EXAMPLE 3 AND COMPARATIVE EXAMPLE 5 & 6

A Mg doped NC powder, having the formula Li_{0.99}(Ni_{0.8415}Co_{0.1485}Mg_{0.0100})_{1.01}O₂, where Li/M′ ratio is 0.98, is obtained through the same method as in ENC1.1, except that MgO as a dopant source is added during blending step and the sintering temperature is 750° C. The final NC product is labeled NC3 having the formula 1 mol % Mg doped Li_{0.99}(Ni_{0.8415}Co_{0.1485}Mg_{0.0100})_{1.01}O₂. CNC3 is prepared using the same method as in NC3, except that the sintering temperature is 770° C.

The crystallite size and Li impurities of NC3 and CNC3 are evaluated by the same method as in Explanatory Example 1. These analysis results are shown in Table 3.

The full cell testing of NC3 is performed using a “B1: Clamping cell” and “B3: Standard pouch cell” in the range of 2.7 to 4.2V at 45° C. For each cell test type, battery IDs labelled as EX3 and CEX5, respectively. The full cell testing of CNC3 is performed using a “B3: Standard pouch cell” in the range of 2.7 to 4.2V at 45° C. For the analysis, battery ID is CEX6. These full cell testing results are shown in Table 3 and FIG. 7.

It can be concluded that EX2 and EX3 also show the enhanced cycle stability when applied in the clamping cell, as shown in FIG. 6 and FIG. 7.

TABLE 3
Properties of Examples 1-3 and Comparative Examples 1-6.

| | Positive | | | | | Cycle# 80% | Cycle# 80% |
|---|---|---|---|---|---|---|---|
| Battery | electrode | CS | LiOH | Li₂CO₃ | Battery | (2.7-4.2 V, | (2.7-4.3 V, |
| ID | ID | (nm) | (wt %) | (wt %) | type | 45° C.) | 45° C.) |
| EX1 | NC1 | 40.4 | 0.468 | 0.147 | B1 | 1405 | 861 |
| CEX1 | | | | | B3 | 545 | 321 |
| CEX2.1 | CNC1.1 | 45.3 | 0.304 | 0.244 | B1 | 629 | |
| CEX2.2 | | | | | B3 | 560 | |
| CEX2.3 | CNC1.2 | 47.0 | 0.233 | 0.162 | B1 | 543 | |
| CEX2.4 | | | | | B3 | 326 | |
| EX2 | NC2 | 42.2 | 0.438 | 0.193 | B1 | 495 | |
| CEX3 | | | | | B3 | 352 | |
| CEX4 | CNC2 | 47.1 | 0.286 | 0.242 | B3 | 327 | |
| EX3 | NC3 | 42.2 | 0.442 | 0.243 | B1 | 875 | |
| CEX5 | | | | | B3 | 447 | |
| CEX6 | CNC3 | 47.4 | 0.273 | 0.291 | B3 | 392 | |

As shown in Table 3, 1 mol % Mg doped or undoped NC products (NC2 and NC3) have the same crystallite size, which means the Mg dopant doesn't influence the growth of crystallite size during sintering. However, Mg doped NC product with a crystallite size less than 43 nm yields a better long-term battery performance compared to that of ENC1.5 & 1.6.

Additionally, examples having a crystallite size less than 43 nm have better cycle stability. In particular, 2 mol % Al doped NC product (EX1) manufactured at 790° C. has significantly improved cycle stability in a “B1: Clamping cell”.

As discussed above by comparing EX1 and CEX1, EX2 and CEX3 and finally EX3 and CEX5, examples having a LiOH content above 0.4wt % always have a section of capacity fading due to the gas creation during cycling (FIGS. 5.1 to 5.3, FIGS. 6 and 7). When applied in the clamping cell, this phenomena is overcome and finally a good cycle stability is obtained. Therefore, the combination of the high Ni positive electrode material having a crystallite size less than 43 nm and a rigid cell like the clamping cell ensures a good electrochemical performance such as prolonged cycle life.

### EXAMPLE 4 AND COMPARATIVE EXAMPLE 7

An NC powder, having the formula Li₁₊ₐ(Ni_{0.85}Co_{0.15})₁₋ₐO₂, where (1+a)/(1−a) represents the Li/M′ stoichiometric ratio, is obtained through the same method as in ENC1.1, except that the Li/M′ ratio is 0.99 and the sintering temperature is 700° C. The final NC product is labeled NC4.1 having as formula Li_{0.995}M′_{1.005}O₂ with M′=Ni_{0.85}Co_{0.15}. NC4.2 is prepared using the same method as in NC4.1, except that the sintering temperature is 710° C.

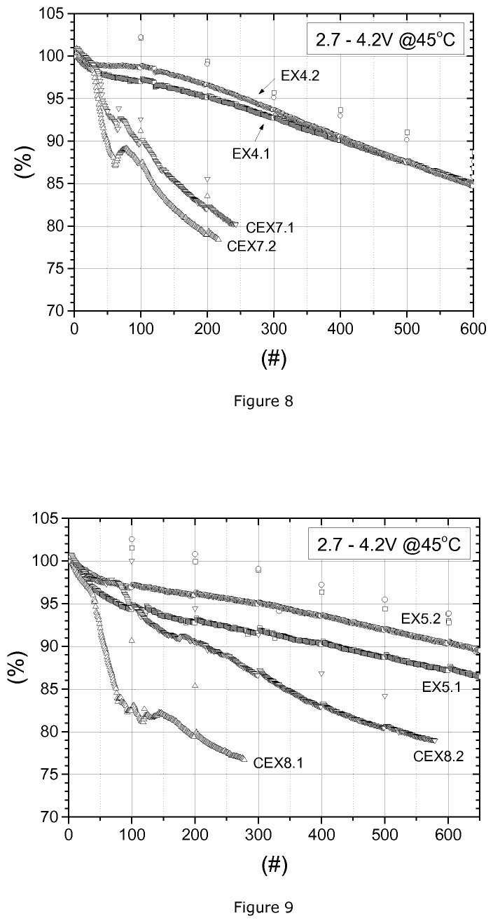

The crystallite size and Li impurities of NC4.1 and NC4.2 are evaluated by the same method as in Explanatory Example 1. These analysis results are shown in Table 4. The full cell testing of NC4.1 and NC4.2 is performed using a “B1: Clamping cell” and “B3: Standard pouch cell” in the range of 2.7 to 4.2V at 45° C. For each cell test type, the batteries are labelled as EX4.1, EX4.2, CEX7.1 and CEX7.2, respectively. These full cell testing results are shown in Table 4 and FIG. 8.

### EXAMPLE 5 AND COMPARATIVE EXAMPLE 8

NC5.1 is prepared using the same method as in NC4.1, except that the sintering temperature is 710° C. and Al₂O₃ as a dopant source is added during the blending step. NC5.2 is prepared using the same method as in NC5.1, except that the sintering temperature is 720° C. Both final NCA products NC5.12 & 5.2 have the formula Li_{0.99}(Ni_{0.833}Co_{0.147}Al_{0.020})_{1.01}O₂.

The crystallite size and Li impurities of NC5.1 and NC5.2 are evaluated by the same method as in Explanatory Example 1. These analysis results are shown in Table 4. The full cell testing of NC5.1 and NC5.2 is performed using a “B2: Cylindrical cell” and “B3: Standard pouch cell” in the range of 2.7 to 4.2V at 45° C. For each cell test type, batteries are labelled as EX5.1, EX5.2, CEX8.1 and CEX8.2, respectively. These full cell testing results are shown in Table 4 and FIG. 9.

TABLE 4
Properties of Examples

| | Positive | | | | | |
|---|---|---|---|---|---|---|
| | electrode | CS | LiOH | Li₂CO₃ | Battery | Cycle# 80% |
| Battery ID | ID | (nm) | (wt %) | (wt %) | type | (45° C.) |
| EX4.1 | NC4.1 | 35.3 | 0.714 | 0.206 | B1 | 818 |
| CEX7.1 | | | | | B3 | 182 |
| EX4.2 | NC4.2 | 37.5 | 0.556 | 0.196 | B1 | 777 |
| CEX7.2 | | | | | B3 | 247 |
| EX5.1 | NC5.1 | 35.1 | 0.579 | 0.196 | B2 | 1096 |
| CEX8.1 | | | | | B3 | 188 |
| EX5.2 | NC5.2 | 37.2 | 0.508 | 0.039 | B2 | 1381 |
| CEX8.2 | | | | | B3 | 529 |

As shown in Table 4, these examples have a much higher LiOH content than NC1 to NC3, because they are manufactured at a much lower sintering temperature. When these examples are applied in “B3: Standard pouch cell”, they show a poor cycling stability. However, when the examples are applied in a clamped or cylindrical cell, they deliver a significantly enhanced cycle stability. The cylindrical cell comprises a jelly roll and a cylindrical steel case. This steel case exercise a certain pressure, which is designed to prevent swelling induced by gas generation inside the cell. Therefore, the combination of the very high Ni positive electrode material having a crystallite size less than 43 nm and the rigid cell like the cylindrical cell provides an extended cycle stability, although the positive electrode materials have a high amount of LiOH, which would make them a priori not suitable for a use in state of the art full cells. When the sintering temperature is further lowered, the crystallite size becomes too low and the LiOH content is more than 0.75 wt %, resulting in the cell's capacity becoming too low.

1-16. (canceled)

17. A secondary Li-ion battery comprising a casing comprising as battery parts:
a positive electrode comprising a powderous positive electrode active material,
a negative electrode,
a separator, and
an electrolyte,
wherein the casing is provided with means for maintaining a predetermined exterior form of the casing, said predetermined exterior form allowing to ensure a permanent contact between the battery parts when the battery is in use and when a pressure exercised from inside the casing is generated during said use, and
wherein the positive electrode active material has the general formula Li₁₊ₐ(NiₓCo_{y}M_{z})₁₋ₐO₂, wherein M=M′_{1-b}A_{b}, M′ being either one or both of Al and Mg, and A being a dopant with b≤0.10, and wherein −0.03≥a≥0.03, 0.80≤x≤0.95, 0.05≤y≤0.20, z≤0.10, with x+y+z=1, and wherein the positive electrode active material has a crystallite size ≤43 nm as determined by the Sherrer equation based on the peak of the (104) plane obtained from the X-ray diffraction pattern using a Cu Kα radiation source, and wherein the positive electrode active material further comprises between 0.40 and 0.75 wt % LiOH.

18. The secondary Li-ion battery of claim 17, wherein the battery comprises a rigid casing configured to withstand the pressure exercised from inside the casing.

19. The secondary Li-ion battery of claim 17, wherein the battery comprises a flexible casing whereupon pressure is applied to ensure a permanent contact between the battery parts.

20. The secondary Li-ion battery of claim 17, wherein a is between −0.005 and −0.010.

21. The secondary Li-ion battery of claim 17, wherein the positive electrode active material has a crystallite size between 30 and 43 nm.

22. The secondary Li-ion battery of claim 17, wherein 0≤z≤0.03.

23. The secondary Li-ion battery of claim 17, wherein A is one or more of Ti, B, Ca, Ga and Nb.

24. The secondary Li-ion battery of claim 17, wherein the positive electrode active material has the general formula Li₁₊ₐ(NiₓCo_{y}Al_{z})₁₋ₐO₂, wherein −0.03≤a≤0.03, 0.80≤x≤0.90, 0.10≤y≤0.20, and either z=0 or 0.02≤z≤0.05, with x+y+z=1.

25. The secondary Li-ion battery of claim 17, wherein the powderous positive electrode active material has a particle size distribution with a D50 between 10 to 15 μm.

26. The secondary Li-ion battery of claim 17, wherein the battery is either one of a cylindrical 18650, 20700, 21700, 22700, 26650 or 26700 lithium-ion cell, or a hard-case prismatic lithium-ion cell, whereby the battery may be incorporated in a pack of multiple batteries.

27. A method for preparing the secondary Li-ion battery according to claim 17, the method comprising the steps of:
A) providing a positive electrode comprising a powderous positive electrode material,
B) providing a negative electrode,
C) providing an electrolyte,
D) providing a separator, and
E) assembling the materials provided in steps A) to D) in a casing, wherein the casing is provided with means for maintaining a predetermined exterior form of the casing, said predetermined exterior form allowing to ensure a permanent contact between the battery parts when the battery is in use and when a pressure exercised from inside the casing is generated during said use, and wherein step A) comprises the following substeps for providing the powderous positive electrode material:
a) providing either a metal hydroxide or a metal oxyhydroxide comprising Ni and Co, and being prepared by the co-precipitation of metal salts with a base, and
b) when z>0, providing a precursor compound comprising one or both of Mg and Al,
c) mixing the compounds of steps a) and b) with one of LiOH, Li₂O or LiOH.H₂O, and
d) heating the mixture of step c) at a temperature between 700 and 750° C. under oxygen.

28. The method according to claim 27, wherein the metal hydroxide or metal oxyhydroxide comprising Ni and Co, further comprises A.

29. The method according to claim 27, wherein the precursor compound comprising one or both of Mg and Al is an oxide of one or both of Mg and Al.

30. A battery pack of an electric vehicle or a hybrid electric vehicle comprising the secondary Li-ion battery of claim 17.

31. The battery pack of claim 30, wherein the battery is cycled between at least 2.50V and at most 4.50 V at a charging/discharging rate of at least 0.8 C/0.8 C.

32. The battery pack of claim 31, wherein the battery has an 80% retention capacity after at least 1000 cycles at a 1 C charge/1 C discharge rate.
